(19) United States
(12) Patent Application Publication
(10) Pub. No.: US 2026/0187620 A1
(43) Pub. Date: Jul. 2, 2026

(54) DELIVERING USER DATA USING RESOURCE ADDRESS

(71) Applicant: VISA INTERNATIONAL SERVICE ASSOCIATION, San Francisco, CA (US)

(72) Inventors: Hari Krishna ANNAM, Austin, TX (US); Suresh Kalakrishnan, Cedar Park, TX (US); Penny Jurss, Leander, TX (US)

(73) Assignee: VISA INTERNATIONAL SERVICE ASSOCIATION, San Francisco, CA (US)

(21) Appl. No.: 19/126,918

(22) PCT Filed: Nov. 7, 2023
(86) PCT No.: PCT/US2023/078958

§ 371 Date: May 2, 2025

Related U.S. Application Data
(60) Provisional application No. 63/423,326, filed on Nov. 7, 2022.

(51) Int. Cl. G06Q 20/36

(52) U.S. Cl. CPC G06Q 20/3674

(57) ABSTRACT

Methods and systems for provisioning a token on a mobile device without the installation of an application thereon are provided. A server computer can: receive credentials associated with a user account; encrypt the credentials; generate a payload in form of a remote resource address; generate an application associated with the remote resource address; transmit the application to a mobile device in response to the mobile device navigating to the remote resource address; receive the payload from the application when the application is executed on the mobile device; and provision a token associated with the user account on a digital wallet of the mobile device when the application is executed on the mobile device without being installed thereon.

### CROSS-REFERENCE TO RELATED APPLICATIONS

This application is a PCT application which claims the benefit of priority from U.S. Provisional Application No. 63/423,326, filed Nov. 7, 2022, titled “DELIVERING USER DATA USING RESOURCE ADDRESS,” which is incorporated by reference in its entirety for all purposes.

### BACKGROUND

Digital wallets allow a user of a mobile device to complete transactions or provide credentials, such as transportation credentials or an event ticket. However, in order to provision a credential or transaction card on the digital wallet, the user has to first download an application associated with the provider of the credential or transaction card to the mobile device. This results in inefficiency in adding a credential or transaction card to a digital wallet. Further, the user may have to use storage space on the mobile device for an application that is used a single time to provision the credential or transaction card and is not used again. This is especially the case when the user wishes to provision a newly generated account, or an existing account that is not associated with a physical card to a digital wallet. This results in an inefficient and disjointed user experience when a user is attempting to add a credential or transaction card to a digital wallet for subsequent use.

Embodiments of the present application address these and other problems individually and collectively.

### SUMMARY

One embodiment includes a method. The method includes: receiving, by a server computer, credentials associated with a user account; encrypting, by the server computer, the credentials with an encryption key to generate encrypted credentials, wherein the encrypted credentials are unique to the user account; generating, by the server computer, a payload in form of a remote resource address, wherein the payload comprises the encrypted credentials; generating, by the server computer, an application associated with the remote resource address; transmitting, by the server computer, the application to a mobile device in response to the mobile device navigating to the remote resource address, wherein navigating to the remote resource address on the mobile device triggers execution of the application on the mobile device without the application being installed thereon; receiving, by the server computer from the mobile device, the payload from the application when the application is executed on the mobile device, wherein the application retrieves the payload from the remote resource address; and provisioning, by the server computer, a token associated with the user account on a digital wallet of the mobile device when the application is executed on the mobile device without being installed thereon.

Another embodiment includes a server computer comprising: one or more processors; and a computer-readable medium including code, executable by the one or more processors to perform steps including: receiving credentials associated with a user account; encrypting the credentials with an encryption key to generate encrypted credentials, wherein the encrypted credentials are unique to the user account; generating a payload in form of a remote resource address, wherein the payload comprises the encrypted credentials; generating an application associated with the remote resource address and the encrypted credentials; transmitting the application incorporating the remote resource address to a mobile device in response to the mobile device navigating to the remote resource address, wherein navigating to the remote resource address on the mobile device triggers execution of the application on the mobile device without the application being installed thereon; receiving, from the mobile device, the payload from the application when the application is executed on the mobile device, wherein the application retrieves the payload from the remote resource address; and provisioning a token associated with the user account on a digital wallet of the mobile device when the application is executed on the mobile device without being installed thereon.

Another embodiment includes a method. The method includes: receiving, by the mobile device, a selection of the remote resource address; responsive to the selection, navigating, by the mobile device, to the remote resource address; responsive to navigating, receiving, by the mobile device, an application; executing, by the mobile device, the application on the mobile device without installing the application, wherein the application vanishes from the mobile device upon execution; receiving, by the mobile device, a token from the server computer in response to executing the application on the mobile device, wherein the token is provisioned on a digital wallet of the mobile device; and conducting, by the mobile device, a transaction using the token provisioned on the mobile device.

Further details regarding embodiments can be found in the Detailed Description and the Figures.

### BRIEF DESCRIPTION OF THE DRAWINGS

FIG. 1 shows a block diagram of a system according to various embodiments.

FIG. 2 shows a block diagram of an exemplary server computer according to various embodiments.

FIG. 3 shows a block diagram of an exemplary user device according to various embodiments.

FIG. 4 shows a flow diagram illustrating a method according to various embodiments.

FIG. 5 shows a flow diagram illustrating a method according to various embodiments.

FIGS. 6A and 6B show flow diagrams illustrating a process according to various embodiments.

FIGS. 7A-7D show flow diagrams illustrating a process according to various embodiments.

FIGS. 8A and 8B show a series of exemplary interfaces according to various embodiments.

### DETAILED DESCRIPTION

Embodiments include systems and methods for enabling a user to complete a provisioning process or other functionality via a mobile device and using an application, without having to download the application to the mobile device. For example, disclosed embodiments can allow a user to interact with or execute application functionality without downloading the application to the mobile device, thereby facilitating a seamless interaction with a resource provider (i.e., the resource provider associated with the application) and optimizing mobile device functionality without using memory space in storing a full application.

For example, a user may qualify for a credential (e.g., gift card) from a credential issuer, such as a resource provider. Typically, in order to receive a digital version of the credential, the user must download an application associated with the resource provider to their mobile device to be able to receive the credential and to load the credential into the digital wallet on their mobile device. However, disclosed embodiments enable the user to receive the credential and load the credential to their digital wallet without the additional requirement of downloading an application. For example, rather than downloading an application, the user can be provided, via a web browser of their mobile device, with a unique uniform resource locator (URL). By navigating to the URL, the user can cause the mobile device to trigger execution of a lightweight application (e.g., an App Clip™ or an Instant App™) configured to support provisioning the token on the digital wallet on the mobile device, without the full application being downloaded on the mobile device. Thus, via the lightweight application, the user can accept the credential and load the credential into their digital wallet without the additional effort, time, and resources associated with downloading an application on the mobile device.

In addition, a user can be limited in their ability to download an application due to lack of available memory on the mobile device. In some embodiments, the user may not be allowed to download applications on the mobile device without administrator approval (e.g., an employee may not be allowed to download applications without employer's approval). The process to get approval for merely provisioning digital credentials may be cumbersome and inefficient. In another example, if the mobile device is not connected to Wi-Fi, the user may have limited bandwidth or available data usage with which to download a full application. Often, when an application is downloaded on a user device, information about the user of the user device is shared with the resource provider or entity managing the application. At a time where users are more sophisticated and/or concerned about the type of personal information they share with third parties, the user may not be willing to share any personal information with the resource provider managing the application. Therefore, the user may be reluctant to download any application on their user device unless absolutely necessary. Thus, disclosed embodiments enable the user to provision credentials on a digital wallet without requiring the user to download and install an application on their mobile device. As such, embodiments provide for improved data security, and prevent sharing personal information with third parties against the wishes of the owner of the personal information. Therefore, embodiments allow for compliance with domestic and foreign data privacy laws and regulations (e.g., General Data Protection Regulation (GDPR), California Consumer Privacy Act (CCPA)).

In an example of disclosed embodiments, a server computer can receive credentials associated with a user account. The credentials can be, for example, information unique to a user account such as a primary account number (PAN), card verification value (CVV), account holder name, account holder address, etc. The server computer can generate encrypted credentials by encrypting the received credentials with an encryption key. The server computer can then generate a payload in the form of a remote resource address, such as a URL, and can generate an application (e.g., a lightweight application in form of an App Clip™ or an Instant App™) associated with the remote resource address.

In disclosed embodiments, the server computer can transmit the application to a mobile device in response to the mobile device navigating to the remote resource address. For example, navigating to the remote resource address on the mobile device triggers execution of the application on the mobile device without the application being installed thereon. When the application is executed on the mobile device, the payload (e.g., the encrypted credentials) is received by the server computer from the application when the application is executed on the mobile device. For example, the application can retrieve the payload form the remote resource address and cause the mobile device to transmit the payload to the server computer.

Finally, the server computer can provision the credentials on a digital wallet of the mobile device when the application is executed by the mobile device. This can be done without the application being installed on the mobile device. For example, the application executed by the mobile device can be a lightweight version of application configured to enable the mobile device to complete one or more tasks. According to various embodiments, the server computer provisions the credentials on the digital wallet by obtaining and provisioning a token associated with the user account on the digital wallet.

Systems and methods described herein facilitate seamless use of a lightweight application to enable adding a credential (e.g., an account identifier, a payment method or other form of certificate or credential) to a digital wallet without the user needing to download an application to the mobile device. Accordingly, embodiments improve the user experience and enable the user to add to a digital wallet without the additional time and resources (e.g., memory and data usage), and data sharing associated with downloading an application.

Accordingly, disclosed embodiments enable a use, via a mobile device, to execute an application accessed via a remote resource address without having to download the application to the mobile device. Prior to discussing specific embodiments, some terms may be described in detail.

A “user” may include an individual. In some examples, a user may be associated with one or more personal accounts and/or mobile devices. The user may also be referred to as a cardholder, account holder, or consumer in some embodiments.

A “mobile device” (sometimes referred to as a mobile communication device or a user device) may include any suitable electronic device that may be transported and operated by a user, which may also provide remote communication capabilities to a network. A mobile communication device may communicate using a mobile phone (wireless) network, wireless data network (e.g., 3G, 4G, 5G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches, rings, glasses), vehicles such as automobiles and motorcycles, personal music players, hand-held specialized readers, etc. A mobile device may include any suitable hardware and software for performing such functions, and may also include multiple devices or components (e.g., when a device has remote access to a network by tethering to another device—i.e., using the other device as a modem—both devices taken together may be considered a single mobile device).

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes, and other login information, etc.

“Payment credentials” may include any suitable information associated with an account (e.g., a payment account and/or payment device associated with the account). Such information may be directly related to the account or may be derived from information related to the account. Examples of payment credentials may include a PAN (primary account number or “account number”), username, expiration date, and verification values such as CVV (card verification value), dCVV (dynamic card verification value), CVV2 (card verification value 2), CVC3 card verification values, a token, etc. An example of a PAN is a 16-digit number, such as “4000 1234 5678 9010.” In some embodiments, payment credentials can include additional information that may be used for authorizing a transaction. For example, payment credentials can include a cryptogram associated with the transaction.

A “digital wallet” can include an electronic device that allows an individual to conduct electronic commerce transactions. A digital wallet may store user profile information, credentials, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card. A digital wallet may include a transfer application.

A “credential issuer” may be an entity that can provide a credential to a user. For example, a credential issuer can provide a credential such as a digital payment card, a digital gift card, a digital transit pass, a digital ticket, a digital license, etc. The credential can be provisioned on a digital wallet of a mobile device such that the mobile device is capable of using the credential to complete a transaction, prove identification, gain entry to an event, etc. A credential issuer can be a resource provider, a bank, a transit authority, a ticketing system, a licensing agency, a health agency, and the like, or any entity providing a digital credential unique to a user or users.

A “resource provider” may be an entity that can provide a resource such as goods, services, information, and/or access. Examples of resource providers include merchants, data providers, transit agencies, governmental entities, venue and dwelling operators, etc. A “merchant” may typically be an entity that engages in transactions and can sell goods or services, or provide access to goods or services.

A “server computer” may include a powerful computer or cluster of computers associated with a payment processor or other financial entity. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers.

A “credential issuer computer” can include a computer, server, or series of interconnected computers maintained by or associated with a credential issuer. A credential issuer can include a resource provider can include an entity (e.g., a merchant, retailer) providing resources (e.g., goods/services) to a user. The credential issuer computer can provide a webpage/portal allowing for users to access an interactive computing environment associated with the credential issuer. The information provided by the user can be referred to as “interaction data.” The interaction data can include information relating to the requested goods/services (e.g., item numbers, a total value for the goods/services), user details (e.g., username, age, address), user device details, etc.

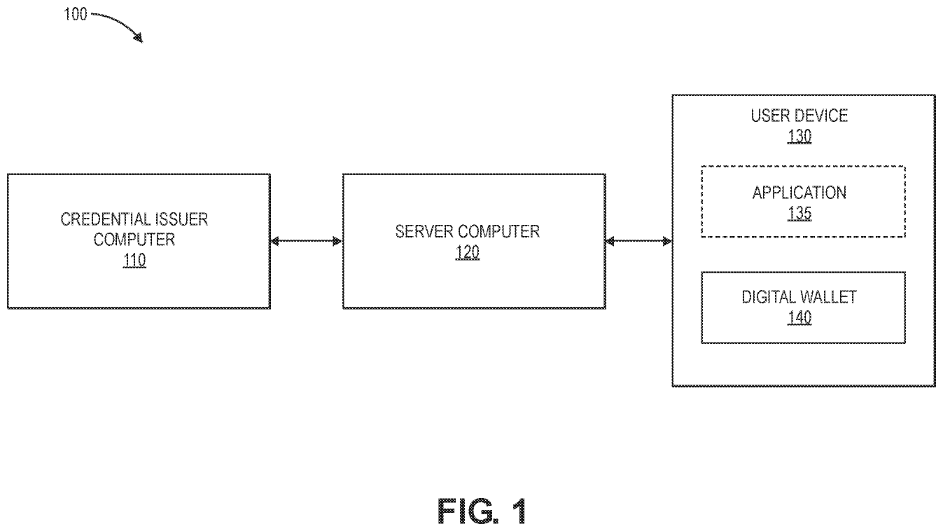

FIG. 1 shows a system 100 comprising a number of components. The system 100 comprises a credential issuer computer 110, a server computer 120, and a mobile device 130 each of which may be embodied by one or more computers. One or more components of the system 100 can be used to provision a token on the mobile device 130 according to disclosed embodiments.

The credential issuer computer 110 may be associated with a credential issuer. A credential issuer can refer to an entity issuing the credential to the user. For example, a credential issuer can be a resource provider, which may be an entity that can provide a resource such as goods, services, information, and/or access. Examples of a resource provider include merchants, access devices, secure data access points, etc. A merchant may typically be an entity that engages in transactions and can sell goods or services, or provide access to goods or services. The resource provider may accept multiple forms of payment (e.g., a payment card such as a credit or debit card) and may use multiple tools to conduct different types of transactions. In another example, a credential issuer can be a bank, where the bank issues a credential such as a bank card associated with a user account or a prepaid card.

As an example, as a reward for opening a new account, a bank can give a credential (e.g., a prepaid gift card) to a user. The prepaid gift card can be associated with a resource provider. Thus, the credential issuer can provision credentials associated with other entities or that can be used to complete transactions with other entities. In another example, a resource provider can give a credential (e.g., a prepaid card) to a user where the credential is a prepaid debit card that can be used to complete a transaction with any resource provider that accepts the prepaid debit card.

An example of the mobile device 130 is a device such as a smart phone, smart watch, wearable device, etc. capable of executing one or more applications stored thereon. For example, the mobile device 130 may be configured to acquire and execute an application 135 without the application 135 being downloaded and installed on the mobile device 130. For example, the application 135 may be a lightweight application in the form of an App Clip™ or an Instant App™ configured to support provisioning the token on the digital wallet. The application 135 may be an application generated by the server computer 120 in response to a request by the credential issuer computer 110 to generate an application and a remote resource address associated with a user account of the user.

The mobile device 130 may be capable of interacting with the server computer 120. The mobile device 130, credential issuer computer 110, and the server computer 125 may all be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Messages between the computers, networks, servers, and devices may be transmitted using a secure communications protocols such as, but not limited to, Secure File Transfer Protocol (SFTP); Secure Hypertext Transfer Protocol (HTTPS), Secure Socket Layer (SSL), ISO (e.g., ISO 8583) and/or the like.

The server computer 120 may be associated with a payment processor, which may be an entity that enables payment processing between a resource provider and a user (e.g., a user associated with the mobile device 130). The server computer 120 can communicate with the credential issuer computer 110, for example, to receive a request to generate remote resource address (e.g., a URL) including a payload for a specific user. For example, the credential issuer computer 110 can transmit a request to the server computer 120, where the request includes credentials associated with a user account.

The server computer 120 can, in response to the request, encrypt the credentials and generate a payload including the encrypted credentials. The server computer 120 can also generate an application associated with the remote resource address. This application can be, for example, a lightweight application, such as an App Clip™ or Instant App™, configured to complete a particular task, such as provision the token on the digital wallet. The generated application 135 can be transmitted to the mobile device 130. For example, the user may navigate to the remote resource address via a web browser installed on the mobile device 130. Navigating to the remote resource address can trigger execution of the generated application 135 on the mobile device 130.

When the application 135 is executed by the mobile device 130, the application 135 can retrieve the payload from the remote resource address and transmit the payload (containing the encrypted credentials) to the server computer 120. In response to receiving the payload, the server computer 120 can provision a token associated with the user or the user account on a digital wallet 140 of the mobile device 130. As previously described, the application 135 can be a lightweight application that executes a particular task or function, but is not installed on the mobile device 130. The lightweight application is configured to deliver digital content to a mobile device 130 without being installed on the mobile device 130.

Accordingly, the components of system 100 can interact to enable the credential provider to provision a token (e.g., a payment card) on the mobile device 130 using the application 135 (e.g., a lightweight application) and the unique remote access address without the user having to download and install an application on the mobile device 130.

The server computer 120 may include data processing subsystems, networks, and operations used to support and deliver authorization services, exception file services, and clearing and settlement services. For example, the server computer 120 may include a server coupled to a network interface (e.g., by an external communication interface), and databases of information. The server computer 120 may be representative of a transaction processing network. An exemplary transaction processing network may include VisaNet™. Transaction processing networks such as VisaNet™ are able to process credit card transactions, debit card transactions, and other types of commercial transactions. VisaNet™, in particular, includes a VIP system (Visa Integrated Payments system) which processes authorization requests and a Base Il system which performs clearing and settlement services. The server computer 120 may use any suitable wired or wireless network, including the Internet.

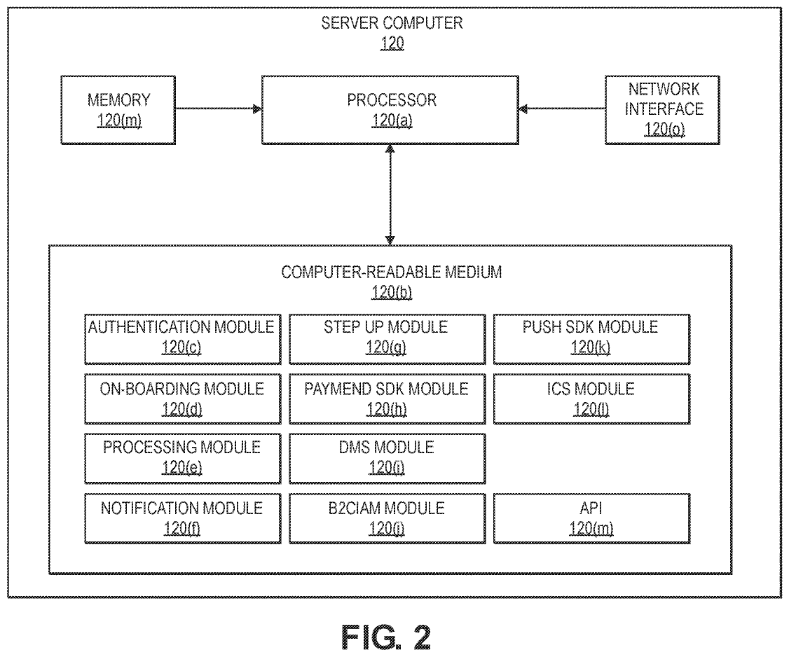

An example of the server computer 120 is illustrated in FIG. 2. The server computer 120 may include a processor 120(a) operatively coupled to a computer readable medium 120(b) (e.g., one or more memory chips, etc.), memory 120(n), and a network interface 120(o).

The computer readable medium 125(b) may include instructions or code, executable by a processor, e.g., processor 125(a). The instructions may include instructions for communicating with the mobile device 130, and/or credential issuer computer 110 to provision a token on the mobile device 130, and instructions for any other suitable function as described herein. For example, the computer readable medium 125(b) may store: an authentication module 120(c); an on-boarding module 120(d); a processing module 120(e); a notification module 120(f); a step-up authentication module 120(g); a payment SDK module 120(h); a device management system (DMS) module 120(i); a consumer identity and access management (B2CIAM) module 120(j); a push SDK module 120(k); an ICS module 120(l); and an application programming interface 120(m). In some embodiments, one or more of the modules can be part of an application generation platform. For example, the application generation platform can include the on-boarding module 120(d). In some examples, the application generation platform can be a separate system from the server computer 120, or can be a sub-system within the server computer 120.

In some embodiments, the server computer 120 may have different architectures. For example, in some embodiments, each module can be associated with a separate processor, memory, computer-readable medium within the server computer. In other embodiments, a first processor may be communicatively connected to a first computer-readable medium storing: an authentication module 120(c); an on-boarding module 120(d); a processing module 120(e); a notification module 120(f); and a first API. In this example, a second processor may be communicatively coupled with a second computer-readable medium storing: a step-up authentication module 120(h); a payment SDK module 120(h); a DMS module 120(i); a B2CIAM module 120(j); a push SDK module 120(k); an ICS module 120(l); and a second API. In yet another example, certain module and/or functionality can be executed by one or more systems separate from the server computer 120. As a non-limiting example, the authentication module 120(c) can be executed by a separate authentication system that is configured to communicate with the server computer 120 and the credential issuer computer 110.

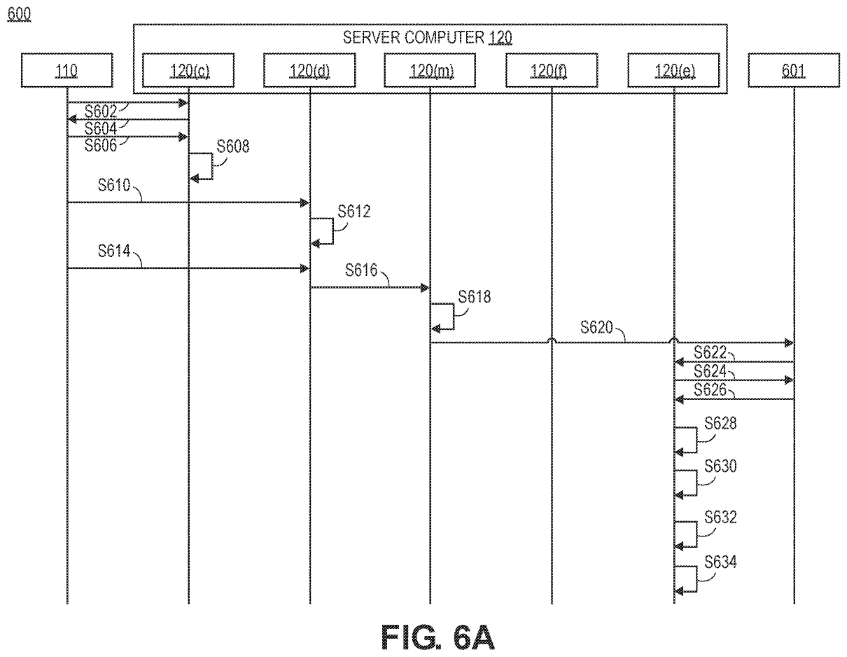

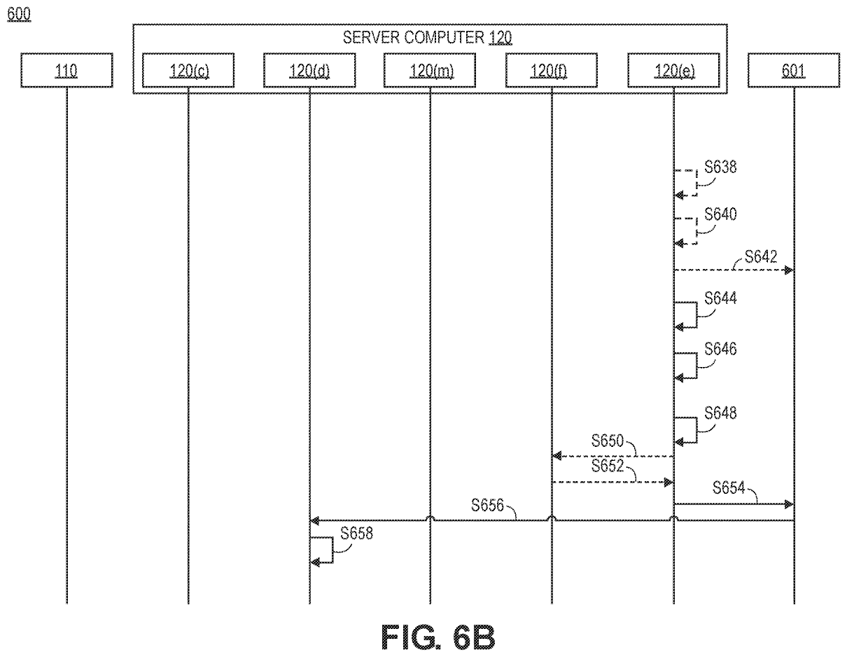

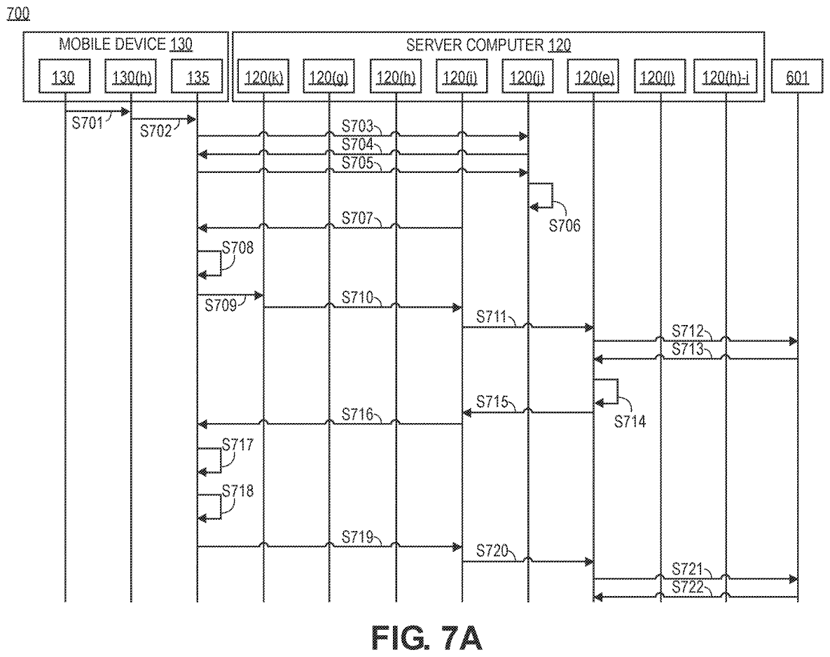

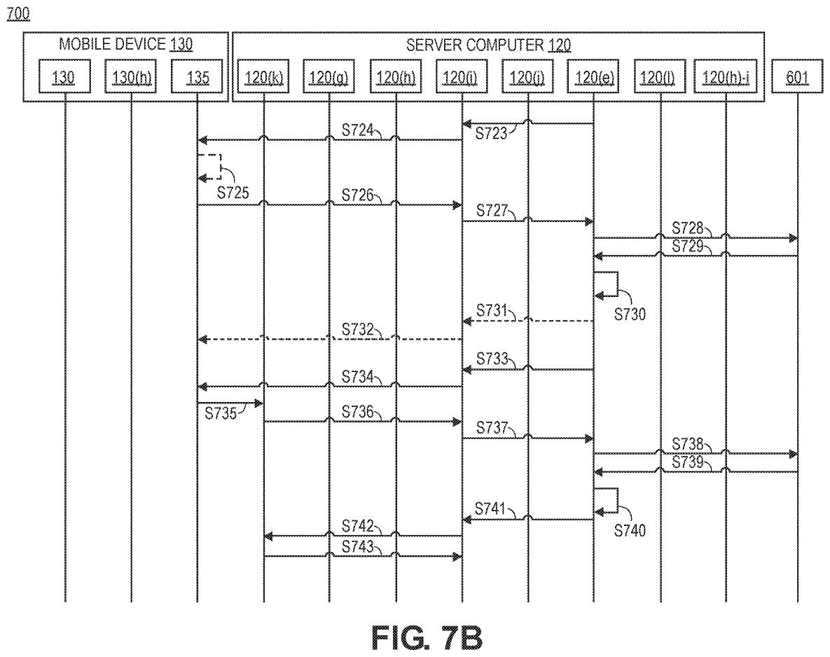

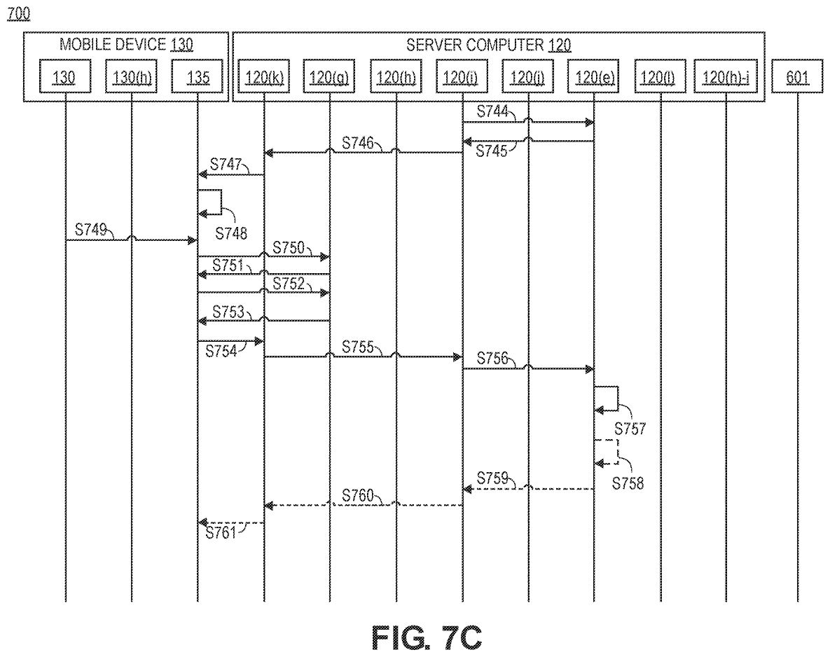

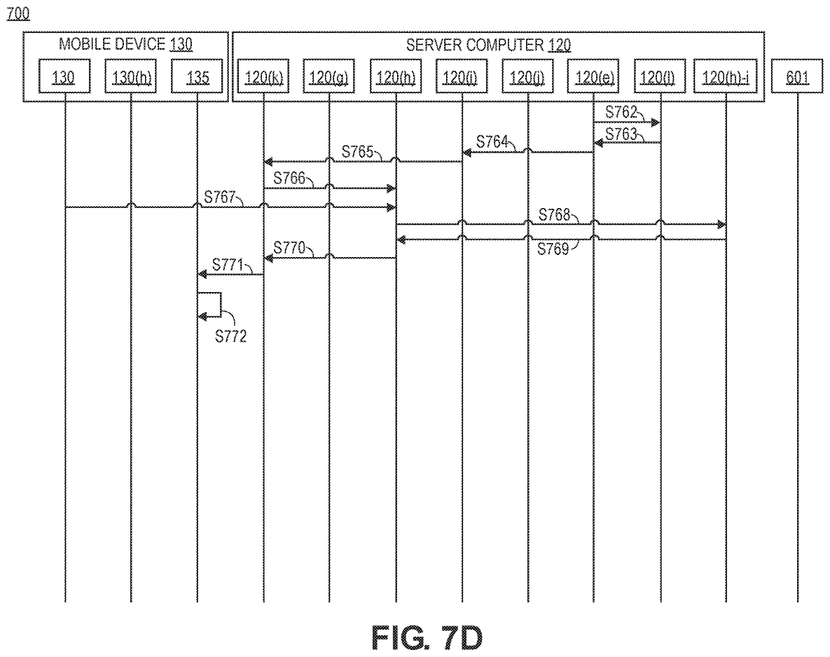

The modules stored by the computer-readable medium 120(b) can be used to complete processes for provisioning a token on the mobile device 130 without downloading an application to the mobile device 130. For example, the modules can be configured to generate a remote resource address for a particular user/user account, provide the remote resource address to the mobile device 130, and, in response to the mobile device 130 navigating to the remote resource address, providing a payload to the server computer 120 to cause the server computer 120 to provision a token on the digital wallet 140 of the mobile device 130. The particular functionality of each module will be discussed in further detail below in connection with FIGS. 6A-7D.

The memory 120(n) can be a database, or other memory, physical storage device, or cloud-based storage device. The memory 120(n) can, for example, store credential or authentication information associated with one or more credential issuer and/or one or more users. The memory 120(n) can further include registration information associated with a user. For example, a user may be associated with one or more digital wallets. The memory 120(n) can store information that points to one or more digital wallets of the user.

The computer readable medium 120(b) can also include instructions stored thereon that, when executed by the processor 120(a), cause the server computer 120 to perform a method including: receiving, by a server computer, credentials associated with a user account; encrypting, by the server computer, the credentials with an encryption key to generate encrypted credentials, wherein the encrypted credentials are unique to the user account; generating, by the server computer, a payload in form of a remote resource address, wherein the payload comprises the encrypted credentials; generating, by the server computer, an application associated with the remote resource address; transmitting, by the server computer, the application to a mobile device in response to the mobile device navigating to the remote resource address, wherein navigating to the remote resource address on the mobile device triggers execution of the application on the mobile device without the application being installed thereon; receiving, by the server computer from the mobile device, the payload from the application when the application is executed on the mobile device, wherein the application retrieves the payload from the remote resource address; and provisioning, by the server computer, a token associated with the user account on a digital wallet of the mobile device when the application is executed on the mobile device without being installed thereon.

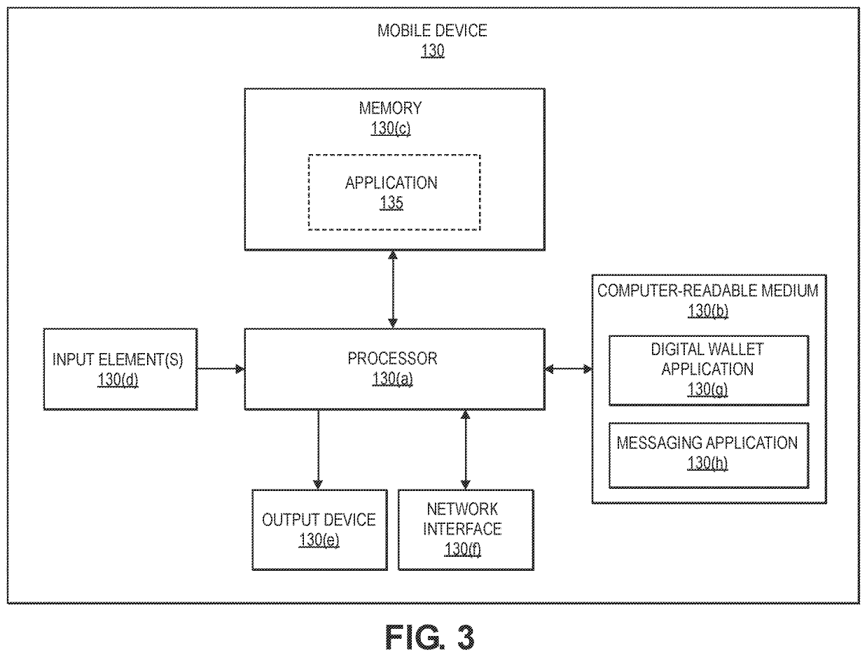

An example of the mobile device 130, according to some embodiments, is shown in FIG. 3. The mobile device 130 may include a processor 130(a) operatively coupled to a computer readable medium 130(b) (e.g., one or more memory chips, etc.), a memory 130(c), input elements 130(d) such as buttons or the like, an output device 130(e) (e.g., a display, a speaker, etc.) and a network interface 130(f). A housing may house one or more of these components.

The computer readable medium 130(b) may include instructions or code, executable by a processor, e.g., processor 130(a). The instructions may include instructions for communicating with a server computer, e.g., the server computer 120 to receive a provisioned token, and instructions for any other suitable function as described herein.

The computer readable medium 130(b) can include a series of instructions that, when executed, cause the processor 130(a) to communicate with the server computer 120 to receive a message including a remote resource address via the messaging application 130(h). The messaging application 130(h) can be a short messaging service (SMS) application, a text messaging component of the mobile device 130, or an instant messaging application (e.g., Whatsapp™), In some embodiments, the remote resource address can be received by scanning, using an input element 130(d) of the mobile device 130 (e.g., a camera), a QR code or barcode. In another example, the remote resource address can be received by the mobile device 130 in a push notification received via near-field communication (NFC) capability of the mobile device 130.

The remote resource address can be provided or otherwise displayed to the user via an output device 130(e) of the mobile device 130. The mobile device 130 can receive, for example, via an input element 130(d) a selection of the remote resource address.

In response to the user navigating to the remote resource address, the mobile device 130 can receive, e.g., via the network interface 130(f), an application associated with the credential issuer. The application can be stored, for example, in the memory 130(c) of the mobile device 130 and can be executed by the processor 130(a). Upon execution, the application is deleted from the memory 130(c). In response to the execution of the application, the mobile device 130 can receive, via the network interface 130(f) and from the server computer 120, a token that is provisioned on the digital wallet application 130(g) of the mobile device 130. For example, the digital wallet application 130(g) can provider the digital wallet 140.

The computer readable medium 130(b) can also include instructions stored thereon that, when executed by the processor 130(a), cause the mobile device 130 to perform a method including: receiving, at a mobile device, a message including a remote resource address comprising encrypted user data, the remote resource address associated with a server computer; receiving, by the mobile device, a selection of the remote resource address; responsive to the selection, navigating, by the mobile device, to the remote resource address; responsive to navigating, receiving, by the mobile device, an application; executing, by the mobile device, the application on the mobile device without installing the application, wherein the application vanishes from the mobile device upon execution; receiving, by the mobile device, a token from the server computer in response to executing the application on the mobile device, wherein the token is provisioned on a digital wallet of the mobile device; and conducting, by the mobile device, a transaction using the token provisioned on the mobile device.

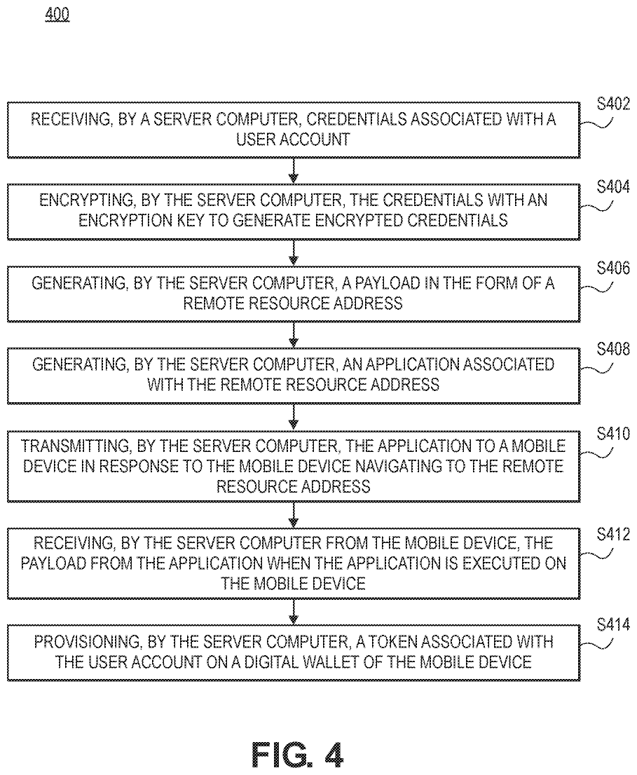

A method 400 according to examples of the present application can be described with respect to FIG. 4.

The method 400 enables a server computer to provision a token on the mobile device associated with a user without an application being downloaded thereon. In a specific example, the method 400 may be used generate a remote resource address configured to cause a lightweight application to execute on the mobile device 130, the execution of which results in the provisioning of a token on a digital wallet of the mobile device.

At step S402, the method 400 can include receiving, by a server computer 120, credentials associated with a user account. For example, in conjunction with a promotion, a resource provider can indicate a user or user account to which to send a gift card. The resource provider can transmit credentials associated with the user, such as a PAN, CVV, name, address, etc., to the server computer. Alternatively in conjunction with a newly generated user account, an account issuer can transmit credentials associated with the user, such as a PAN, CVV, name, address, etc., to the server computer. The server computer may generate a unique remote resource address for the user as described below. In some examples, the user may trigger a credential issuer computer 110 to transmit the user's credentials to the server computer 120 in response to the user completing a task, such as creating an account with the resource provider.

In some examples, the server computer 120 can render a graphical user interface (GUI) associated with an application generation platform of the server computer 120 on the mobile device 130. The GUI can include a field for receiving the credentials associated with the user account. The GUI can be displayed to the user, for example, via an output device 130(e), of the mobile device 130. The mobile device 130 can then transmit the received credentials to the application generation platform, e.g., to the on-boarding application 120(d).

At step S404, the method 400 can include encrypting, by the server computer 120, the credentials with an encryption key to generate encrypted credentials that are unique to the user or user account. For example, the server computer 120 can implement one or more encryption techniques or generate a hash of the credentials.

At step S406, the method 400 can include generating, by the server computer 120, a payload in form of a remote resource address, where the payload includes the encrypted credentials. The remote resource address can be unique to the user based on the credentials received by the server computer 120. As an example, the server computer 120 can generate a payload hash of the payload and incorporate the payload hash in the remote resource address.

At step S408, the method 400 can include generating, by the server computer 120, an application 135 associated with the remote resource address. The application 135 can be, for example, a lightweight application that can be received by the mobile device 130 and executed by the mobile device 130. For example, the application 135 can be an App Clip™ or an Instant App™ configured to support provisioning the token on the digital wallet 140. Subsequent to the application's execution, the application 135 is deleted from the mobile device 130. Thus, the application 135 can execute on the mobile device 130 without the user having to download an application to the mobile device 130.

At step S410, the method 400 can include transmitting, by the server computer 120, the application 135 to a mobile device 130 in response to the mobile device 130 navigating to the remote resource address. For example, navigating to the remote resource address on the mobile device 130 can trigger execution of the application 135 on the mobile device without the application being installed thereon.

At step S412, the method 400 can include receiving, by the server computer 120 from the mobile device 130, the payload from the application 135 when the application is executed on the mobile device 130. For example, the application 135 can retrieve the payload from the remote resource address and transmit the retrieved payload to the server computer 120.

In some embodiments, step S412 can further include receiving, by the server computer 120, the payload when the application 135 is executed on the mobile device 130. The server computer 120 can decrypt the encrypted credentials in the payload using the encryption key and identify a token associated with the credentials (e.g., a token assigned to the user account).

In other embodiments, step S412 can also include authenticating, by the server computer 120, the mobile device 130 and a user of the mobile device 130. For example, the server computer 120 can transmit instructions to cause the mobile device 130 to display a GUI configured to receive authentication information from the user of the mobile device 130. The sever computer 120 can use the authentication information to authenticate the user, or can transmit the authentication information to an authentication service for authentication. If the user is authenticated, the server computer 120 can generate session keys to communicate with the mobile device 130 and can transmit the session keys to the mobile device 130. The server computer 120 can then initialize a session with the mobile device 130 using the session keys and can securely retrieve the payload from the remote resource address. In another embodiment, executing the application 135 on the mobile device 130 can create an encrypted (e.g., secure) communication channel between the mobile device 130 and the server computer 120. Thus, via the secure communication channel, the server computer 120 receives the payload from and transmits the token to the mobile device 130.

At step S414, the method 400 can include provisioning, by the server computer 120, a token associated with the user account on a digital wallet 140 of the mobile device 130 when the application 135 is executed on the mobile device 130 without being installed thereon. Thus, provisioning the token on the digital wallet 140 adds payment capability to the mobile device 130 using the token. In other examples, provisioning the token on the digital wallet can add a certificate or other digital credential capability that is associated with, for example, an event or transportation ticket (e.g., a concert ticket or an airplane ticket), a transit pass (e.g., a Metrocard), a vaccination card, a license (e.g., a digital driver's license or professional license), an identification card, a mobile passport, etc.

In some embodiments, the server computer 120 can transmit instructions to the mobile device 130 to cause the mobile device 130 to display a GUI to the user requesting selection of a digital wallet. For example, the user or the mobile device 130 may be associated with multiple digital wallets, e.g., on different devices or provided by different digital wallet applications. The user can select, via the GUI, a particular digital wallet and the selection is transmitted to the server computer 120 from the mobile device 130. In response, the server computer 120 provisions the token on the selected digital wallet.

In some embodiments, the application 135 is configured to vanish from the mobile device 130 once the token is provisioned on the digital wallet 140. For example, the application 135 can be configured with instructions to cause the mobile device 130 to delete the application 135 from the memory of the mobile device 130 when execution of the application 135 is complete.

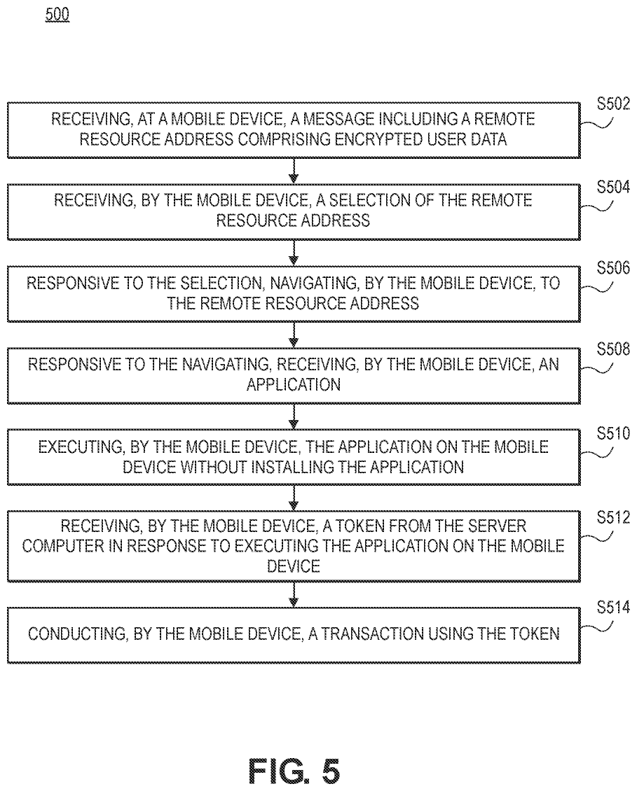

An exemplary process 500 for provisioning a token on a digital wallet 140 of a mobile device 130 and completing a transaction with the token is illustrated in FIG. 5.

At step S502, the process 500 can include receiving, at a mobile device 130, a message including a remote resource address. The remote resource address can include encrypted user data and can be associated with a server computer 120. The remote resource address can be generated by the server computer 120 as described above and can be associated with the user.

At step S504, the process 500 can include receiving, at the mobile device 130, a selection of the remote resource address. For example, the remote resource address can be displayed via the mobile device 130 as a selectable link or button. In other options, a user can scan a QR code, which directs a browser of the mobile device 130 to open a web page that displays the selectable link or button. The user can select the remote resource address by clicking on or pressing the remote resource address, or the link or button associated therewith.

At step S506, the process 500 can include, responsive to the selection, navigating, by the mobile device 130, to the remote resource address. For example, the web browser of the mobile device 130 can navigate to the location pointed to by the remote resource address.

At step S508, the process 500 can include responsive to navigating, receiving, by the mobile device 130, an application 135. The application 135 can be received from the server computer 120. In some embodiments, the application 135 is received and temporarily stored in a memory 130(c) or other storage component of the mobile device 130.

At step S510, the process 500 can include executing, by the mobile device 130, the application 135 on the mobile device 130 without installing the application. Further, the application 135 can be configured such that the application 135 vanishes from the mobile device 130 upon execution. For example, the application 135 can include instructions causing the mobile device 130 to delete or erase the application 135 from the memory 130(c) of the mobile device 130.

At step S512, the process 500 can include receiving, by the mobile device 130, a token from the server computer 120 in response to executing the application 135 on the mobile device 130. The token can be provisioned on a digital wallet 140 of the mobile device 130.

At step S514, the process 500 can conducting, by the mobile device 130, a transaction using the token provisioned on the mobile device 130. For example, using the token in the digital wallet 140, the user can complete a transaction via the mobile device 130, or using tap-to-pay functionality of the mobile device 130 at a merchant location. In other examples, the token can cause the mobile device 130 to display a single-use barcode or QR code, e.g., for entry to a sporting event. In another example, the token can be associated with a digital form of identification, such as a driver's license, or with a digital record, such as a medical record or vaccination card.

A method 600 according to embodiments of the present application can be described with respect to FIGS. 6A and 6B. The method 600 can be performed by one or more components of the credential issuer computer 110, the server computer 120, and the on-boarding service provider 601. For example, one or more modules of the server computer 120 (e.g., the authentication module 120(c), the on-boarding module 120(d), the API 120(m), the processing module 120(e), and the notification module 120(f)) can communicate with the credential issuer computer 110 and the on-boarding service provider 601 to generate a remote resource address and a lightweight application.

The authentication module 120(c) can be configured to execute one or more functions to authenticate the identity of a credential issuer. For example, authentication module 120(c) can authenticate a credential issuer based on authentication information associated with the credential issuer. The authentication module 120(c) can, in some embodiments, receive credential issuer authentication information from the credential issuer computer 110 and communicate with an external authentication system to authenticate the credential issuer.

The on-boarding module 120(d) can be configured to execute one or more functions or processes to generate or facilitate the generation of a remote resource address and a lightweight application. For example, the on-boarding module 120(d) can receive user and user account information and credentials used in generating a remote resource address. For example, the on-boarding module 120(d) can generate a payload containing the user account information that is included in the remote resource address. The on-boarding module 120(d) can also generate the lightweight application, e.g., by providing executable code configured to cause a mobile device 130 to extract the payload and transmit the payload to the server computer 120.

In some embodiments, steps of the method 600 can be completed by an on-boarding service provider 601, e.g., an application generation platform. The on-boarding service provider 601 can be a separate server and communicate with the server computer 120 via a network. In other embodiments, the on-boarding service provider 601 can be part of the server computer 120 or can be a sub-system of the server computer 120. The on-boarding service provider 601 can be configured to communicate with the on-boarding module 120(d) to perform, in full or in part, functionality to generate a lightweight application and a remote resource address.

The processing module 120(e) can be configured to communicate with modules of the server computer 120 and with the on-boarding service provider 601 to transmit and receive information associated with the remote resource address and the lightweight application.

The notification module 120(f) can be configured to manage notification preferences of one or more users. For example, the notification module 120(f) can be associated with a database storing user notification preferences.

The method 600 can enable a credential issuer to generate a unique remote resource address and application for a user or user account.

At step S602, the method 600 includes authenticating a credential issuer via an online gateway, or authentication module 120(c) of the server computer 120. In some embodiments, the authentication module 120(c) can be executed by processor 120(a) of the server computer 120 or can be executed by another processor of the server computer 120. The authentication module 120(c) can be configured to authenticate the credential issuer based on credentials provided via the credential issuer computer 110. In some embodiments, the authentication module 120(c) can communicate with an authentication service, separate from the server computer 120 to authenticate the credential issuer and/or the credential issuer computer 110.

At step S604, the method 600 includes transmitting a message indicating successful authentication of the credential issuer to the credential issuer computer 110 if the resource provider user is successfully authenticated by the authentication module 120(c).

At step S606, the method 600 can include receiving a selection of the on-boarding module 120(d) via the credential issuer computer 110. For example, via the credential issuer computer 110, the credential issuer can select the on-boarding module 120(d) from a list of available applications, tools, or functionality available via the server computer 120.

At step S608, the method 600 includes redirecting communication with the credential issuer computer 110 to the on-boarding application 120(d). For example, upon successful authentication of the credential issuer, a secure communication channel can be established with the on-boarding module 120(d). In some embodiments, the on-boarding module 120(d) can be executed by processor 120(a) of the server computer 120 or can be executed by another processor of the server computer 120. In some embodiments, the on-boarding module 120(d) can be provided be a separate system from the server computer 120.

At step S610, the method 600 includes navigating to an application configuration tool of the on-boarding module 120(d). For example, via a web browser or other interface, the credential issuer computer 110 can access and interact with the application configuration tool of the on-boarding module 120(d), which enables the credential issuer to establish a remote resource address and application unique to a particular user.

At step S612, the method 600 includes rendering a remote resource address webpage configured to receive, from the credential issuer computer 110, user information and/or credentials for use in generating a remote resource address and an application. For example, a GUI can be displayed via the credential issuer computer 110 with one or more input fields configured to receive information associated with a request to generate a remote resource address for provisioning a token on a digital wallet associated with a user.

At step S614, the method 600 includes receiving, at the server computer 120 via the on-boarding module 120(d), credentials associated with a user account. The user account can be an account with the credential issuer (e.g., a bank, a resource provider, or another entity) that is associated with a user, or can be a third-party account associated with an entity other than the credential issuer associated with the user. The credentials can include a PAN, CVV, name, address, or other identifying information associated with the user account. In some embodiments, the credentials can be in the form of plaintext data.

At step S616, the method 600 includes passing the credentials to an API 120(m). In some embodiments, the credentials can be passed to a gateway or API proxy configured to receive the credentials and the request for generating a remote resource address.

At step S618, the method 600 includes authenticating the request. For example, the API 120(m) can authenticate the credentials and user account prior to initiating the generation of the remote resource address. For example, the API 120(m) can communicate with a remote system and/or one or more databases to verify the user account and credentials.

At step S620, the method 600 includes passing the request for the remote resource address and the credentials to an on-boarding service provider 601. In some embodiments, the on-boarding service provider 601 can be provided by an external system, or by a sub-system of the server computer 120. The on-boarding service provider 601 can be associated with the on-boarding module 120(d). In some embodiments, the on-boarding module 120(d) is provided by the on-boarding service provider 601.

At step S622, the method 600 includes transmitting the request for a remote resource address and the credentials to a processing module 120(e). In some embodiments, the processing module 120(e) is associated with an additional external system, or is executed by a sub-system of the server computer 120. In some embodiments, the processing module 120(e) is an application of the on-boarding service 601.

At step S624, the method 600 includes requesting, by the processing module 120(e) from the on-boarding service provider 601, application configuration information. The application configuration information can be, for example, executable code or configuration data associated with desired characteristics of the remote resource address and/or application. Such executable code can include code or code fragments associated with a task to be completed by the application (e.g., provisioning of a token). Configuration data can include, for example, a desired level of encryption for the credentials.

At step S626, the method 600 includes receiving, by the processing module 120(e) from the on-boarding service provider 601, the application configuration information.

At step S628, the method 600 includes creating a unique request ID associated with the request, from the credential issuer computer 110, for a remote resource address associated with a user. The unique ID can be used, for example, in troubleshooting any request errors or errors in the generation of the remote resource address and/or application.

At step S630, the method 600 includes encrypting a payload. The payload can include, for example, one or more of the credentials, the request ID, user account information, or a combination thereof.

At step S632, the method 600 includes creating, by the processing module 120(e), a hash of the encrypted payload.

At step S634, the method 600 can include determining, for the request, whether notifications are enabled. For example, the method may include checking whether contact information, such as a phone number or an email address, is present for the user, and whether a preference for a type of notification is indicated. For example, an indication of whether notifications are enabled for the request can be received as part of the application configuration information. When notifications are enabled, the user may receive push notifications via text or email to the mobile device 130 where the notifications are associated with the provisioned token.

Referring now to FIG. 6B, which is a continuation of the method 600, if notifications are enabled, the method 600 can include optional steps S638-S642. For example, at step S638, the method 600 can include retrieving, e.g., from a database, a phone number associated with the user account and generating a hash of the phone number. Similarly, at step S640, the method 600 can include retrieving, e.g., from a database, an email address associated with the user account and generating a hash of the email address.

If user account information, such as a phone number and email address, is missing or incorrect, at step S642, the method 600 can include generating an error that is passed to the on-boarding service provider 601. Subsequently, the on-boarding service provider 601 can, for example, transmit a notification to the credential issuer computer 110 indicating that the user account contact information is unavailable or incorrect. In some embodiments, the on-boarding service provider 601 can generate a push notification to be provided to the user via the mobile device 130 that requests that the user provider or update contact information associated with the user account.

At step S644, the method 600 includes storing, by the processing module 120(e), the encrypted payload, the payload hash, and, optionally, the phone number hash and the email address hash.

At step S646, the method 600 can include generating, by the processing module 120(e), the remote resource address. For example, the remote resource address can be generated using the stored information, such as the encrypted payload. Further, in some embodiments, the encrypted payload can be included in the remote resource address. As an example, the remote resource address can be in the following format: The remote resource address can be in following format:
“https://<domain>/dlink/push?payloadHash=xyz123 . . . ”
   or
“https://<domain>/dlink/push?payload=ehij12hj . . . ”

At step S648, the method 600 includes determining, by the processing module 120(e) whether notifications are enabled, and transmitting notifications based on indicated preferences if notification are enabled.

At optional step S650, the method 600 can include transmitting the remote resource address to the verification module 120(f) for testing. The verification module 120(f) can verify the remote resource address, for example, by testing the remote resource address correctly points to an associated lightweight application configured to extract and transmit the payload to the server computer 120.

If the remote resource address is verified, the verification module 120(f) can transmit a notice of verification to the processing module 120(e) at step S652.

At step S654, the method 600 can include transmitting, from the processing module 120(e), a notification status to the on-boarding service provider 601. The notification status can indicate the successful creation of the remote resource address associated with the user account.

At step S656, the method 600 can include transmitting, by the on-boarding service provider 601, the status notification to the on-boarding module 120(d).

At step S658, the method 600 can include displaying, by the on-boarding module 120(d) via the credential issuer computer 110, the status (e.g., “success”) and the remote resource address.

Thus, method 600 can enable a credential issuer to generate a unique remote resource address for a user or a user account. The remote resource address can include a payload and can cause a lightweight application to be received and executed by the user's mobile device 130. Execution of the application can transmit the payload to the server computer 120, causing the server computer to provision a token on the digital wallet 140 of the mobile device 130. This process is described in detail below.

An exemplary method 700 for provisioning a token on a mobile device 130 without downloading an application to the mobile device 130 is illustrated in FIGS. 7A-7D. The method 700 can be performed by one or more components of the mobile device 130, the server computer 120, and the on-boarding service provider 601. For example, one or more modules of the server computer 120 (e.g., the push SDK module 120(k), the step-up authentication module 120(g), the payment SDK module 120(h) and backend 120(h)-i, the B2CIAM module 120(j), the processing module 120(e), and the DMS module 120(i)) can communicate with the mobile device 130 and the on-boarding service provider 601 to provision a token on a digital wallet 140 of the mobile device 130.

The step-up authentication module 120(g) can be configured to provide security to the provisioning process. For example, the step-up authentication module 120(g) can be used to generate a one-time password (OTP) to further authenticate the user of the mobile device 130 prior to provisioning the credential. In another embodiment, the step-up authentication module 120(g) can request and verify other user information such as biometric information.

The payment SDK module 120(h) and payment SDK module backend 120(h)-i can be configured to execute one or more processes of functions to generate a token for provisioning to the mobile device 130. For example, the payment SDK module 120(h) and backend 120(h)-i can communicate to generate a token based on received payload information.

The DMS module 120(i) can execute one or more processes or functions to manage content provided to the mobile device 130. For example, the DMS module 120(i) can generate and transmit one or more push notifications to the mobile device 130. The push notifications can be configured to cause the mobile device 130 to display one or more GUIs to the user.

The B2CIAM module 120(j) can be configured to provide access management to one or more modules of the server computer 120. For example, the B2CIAM module 120(j) can control access, by the mobile device 130 or a user of the mobile device 130, to one or more APIs associated with the server computer 120.

The push SDK module 120(k) can provide functionality to push provision the token to the mobile device 130. For example, the push SDK module 120(k) can be configured to receive a token and token information and provision the token on a selected digital wallet installed on the mobile device 130.

The method 700 can be initiated in response to the mobile device 130 receiving a remote resource address. The remote resource address can be received by an input device 130(d) of the mobile device 130. For example, the remote resource address can be received as a text message, as a result of scanning a QR code, or as a push message received via NFC capability of the mobile device 130.

At step S701, the method 700 includes navigating to the remote resource address. For example, the remote resource address can be displayed to the user via a display of the mobile device 130. The user can select or click on the remote resource address to cause, for example, a web browser application of the mobile device 130 to navigate to the remote resource address.

At step S702, the method 700 includes acquiring the application 135 to the mobile device 130. For example, the application 135 can be temporarily stored in a memory 130(c) of the mobile device 130, where it is stored and executed.

At step S703, the method 700 includes registering the mobile device 130 with DMS module 120(i) of the server computer 120. Registering the mobile device 130 can include assigning the mobile device 130 a device ID.

Upon successful registration, at step S704, the method 700 can include transmitting, from the DMS module 120(i) to the application 135 on the mobile device 130, the assigned device ID. In some embodiments, the DMS module 120(i) can also transmit an authentication request, which can prompt the user to enter authentication information in the application 135. Authentication information can include a username/password combination, biometric information, a PIN, or other information that can be used to verify the identity of the user.

At step S705, the method 700 can include transmitting the authentication information to the DMS module 120(i).

At step S706, the method 700 can include generating session keys by the DMS module 120(i) and, at step S707, transmitting a session access token to the application 135 on the mobile device 130.

At step S708, the method 700 can include generating, by the application 135, session keys using the session access token, and at step S709, the application 135 initialize a session via the push SDK module 120(k) using the session keys. The push SDK module 120(k) can include one or more tools or functionality to enable the application 135 to establish a secure communication channel with the server computer 120.

At step S710, the push SDK application 120(k) can communicate with the consumer identity and access management (B2CIAM) module 120(j) to authorize the session. Subsequently, at step S711, the B2CIAM module 120(j) can communicate with the processing module 120(e) to authorize the session with the processing module 120(e). In some embodiments, the B2CIAM module 120(j) can enable the server computer 120 to manage user identities such that the user of the mobile device 130 can be authenticated to the session between the application 135 and the server computer 120.

At step S712, the method 700 includes communicating with the on-boarding service provider 601 to get the details of the application 135. The application details can be stored in a database of the on-boarding service provider 601 and can indicate, for example, the task to be completed by executing the application 135.

At step S713, the method 700 includes communicating, by the on-boarding service provider 601, a status notification of success to the processing module 120(e) if the application details are successfully retrieved.

At step S714, the method 700 includes generating, by the processing application 120(e) a nonce, which is transmitted to the B2CIAM module 120(j) at step S715, and then to the application 135 at step S716.

In response to receiving the nonce, at step S717, the application 135 can generate a welcome screen to be displayed to the user via a display of the mobile device 130. The welcome screen can be displayed, for example, as part of the execution of the application 135.

At step S718, the application 135 can read the encrypted payload included in the remote resource address. For example, reading the encrypted payload can include decrypting the payload using an encryption key to obtain plaintext data. The plaintext data can include the credentials associated with the user account of the user.

At step S719, the method can include transmitting the plaintext data to the B2CIAM module 120(j), which then transmits the plaintext data to the processing module 120(e) at step S720.

At step S721, based on the received plaintext data, the processing application 120(e) can request application configuration information associated with the application 135 from the on-boarding service provider 601. The on-boarding service provider 601 can, for example, query a database to obtain application configuration information associated with the remote resource address and, at step S722, can transmit the application configuration information to the processing module 120(e). In some embodiments, configuration information can include technical capabilities or permission associated with the mobile device 130.

Continuing to FIG. 7B, which describes additional steps of method 700, at step S723, the retrieved information can be transmitted from processing module 120(e) to the B2CIAM module 120(j), and subsequently, at step S724, to the application 135.

In some embodiments, if configuration information is not located at step S721, the method 700 can include optional step S725, which generates a “Feature Not Supported” error indicating that push provisioning is not supported by the mobile device 130.

At step S726, the method 700 can include transmitting the received nonce and device information associated with the mobile device 130 to the B2CIAM module 120(j), and then to the processing application at step S727. In some embodiments, the transmitted data can include the encrypted or decrypted payload. The device information may indicate, for example, a model, an operating system, a configuration, etc. of the mobile device 130.

At step S728, the processing module 120(e) can request application configuration information from the on-boarding service provider 601. At step S729, the on-boarding service provider 601 can provide retrieved application configuration information to the processing module 120(e).

At step S730, the processing module 120(e) can analyze the configuration information to determine whether lightweight application functionality is enabled on the mobile device 130.

If lightweight application functionality is not enabled on the mobile device 130, the method 700 can include optional steps S731 and S732. For example, at step S731 the processing module 120(e) can transmit an error message to the B2CIAM module 120(j), which, at step S732, transmits the error message to the application 135. The error message can be displayed to the user via a display of the mobile device 130 and can indicate that the mobile device 130 does not have provisioning functionality.

At step S733, the method 700 includes transmitting an encrypted SDK payload from the processing module 120(e) to the B2CIAM module 120(j), and at step S734, from the B2CIAM module 120(j) to the application 135.

In response to receiving the encrypted SDK payload, at step S735, the application 135 can generate a request for a list of one or more digital wallets that support provisioning on the mobile device 130 and transmit the list to the push SDK module 120(k). At step S736, the push SDK module 120(k) can transmit the request to the B2CIAM module 120(j).

At step S738, the processing module 120(e) can request application configuration information associated with the application 135 from the on-boarding service provider 601. The on-boarding service provider 601 can, for example, query a database to obtain application configuration information associated with the remote resource address and, at step S739, can transmit the application configuration information to the processing module 120(e). In some embodiments, configuration information can include technical capabilities or permission associated with the mobile device 130.

In some embodiments, at step S740, the processing module 120(e) can verify the configuration information. Verifying the configuration information can include, for example, determining a list of one or more digital wallets available to the user account or installed on the mobile device 130.

At step S741, the list is transmitted to the B2CIAM module 120(j) and, at step S742, is transmitted from the B2CIAM module 120(j) to the push SDK module 120(k).

At step S743, the push SDK module 120(k) can transmit the list of digital wallets to the B2CIAM module 120(j), which, at step S744, shown in FIG. 7C, transmits the list to the processing module 120(e). The processing module 120(e) transmits a response, at step S745, to B2CIAM module 120(j), which is transmitted, at step S746, to the push SDK module 120(k), which is further transmitted, at step S747, to the application 135.

At step S748, the method 700 can include displaying, by the mobile device 130, a GUI listing the one or more digital wallets available to the user for provisioning a token. The user can select a digital wallet (e.g., digital wallet 140) from the displayed list at step S749.

At step S750, the method can include initializing an access token with the step-up authentication module 120(g). The step-up authentication module 120(g) can be, for example, an additional layer of security configured to authenticate the user prior to provisioning the token. The step-up authentication module 120(g) can verify the access token and transmit a response message to the application 135 at step S751.

At step S752, the method 700 can include transmitting, by the application 135, the encrypted SDK payload received at step S734. The step-up authentication module 120(g) can further authenticate the user, for example, by providing a one-time passcode (OTP) or other method of multi-factor authentication (MFA) to authenticate the user. At step S753, the step-up authentication module 120(g) can transmit the result of the authentication to the application 135.

If the user was successfully authenticated, the method 700 can proceed to step S754, in which the application 135 transmits information indicating the selected digital wallet 140 to the push SDK module 120(k). The push SDK module 120(k) generates a request for a token to be provisioned on the digital wallet 140 and transmits the request, at step S755, to the B2CIAM module 120(j), which, at step S756, transmits the request to the processing module 120(e).

At step S757, the processing module 120(e) received the request and determines that the request is associated with application 135 executing on the mobile device 130.

In some embodiments, the method 700 can include optional steps S758-S761. At step S758, the method can include verifying, by the processing module 120(e) that the user was verified successfully by the step-up module 120(g). If the user was not successfully verified, the processing module 120(e) can transmit, at step S759, an error message to B2CIAM module 120(j). At step S760, the B2CIAM module 120(j) can transmit the error message to the push SDK module 120(k), which, at step S761, transmits the error message to the application 135. In response to receiving the error message the application 135 can generate and display a GUI including the error message on the mobile device 130.

At step S762, the processing module 120(e) can request a push payload from the Issuer and Consumer Serviced (ICS) module 120(l). The ICS module 120(l) can generate the push payload and, at step S763, transmit the push payload to the processing module 120(e). At step S764, the processing module 120(e) transmits the push payload to the B2CIAM module 120(j), which, in turn at step S765, transmits the push payload to the push SDK module 120(k).

The push SDK module 120(k) can tokenize the push payload and, at step S766, can transmit the tokenized push payload to the payment SDK module 120(h). Simultaneously, or in tandem, the payment SDK module 120(h) can receive, from the mobile device 130 at step S767, confirmation that the user wishes to complete the provisioning process.

At step S768, the method 700 includes transmitting, from the payment SDK module 120(h), the tokenized push payload to a back-end system of the payment SDK module 120(h)-i. The back-end system of the payment SDK module 120(h)-i can include, for example, additional functionality that is not directly accessible to the mobile device 130. At step S769, one or more processes of the back-end system of the payment SDK module 120(h)-i can validate the tokenized payload and transmit a token including the tokenized payload to the payment SDK module 120(h). In turn, at step S770, the payment SDK module 120(h) transmits the token to the push SDK module 120(k), which, at step S771, provisions the token on the mobile device 130 via the application 135. For example, the token can be provisioned on the selected digital wallet 140.

At step S772, the application 135 can display a message to the user indicating that the token was successfully provisioned on the digital wallet 140. In some embodiments, the application 135 can be automatically deleted from the memory 130(c) of the mobile device 130 upon completion of the method 700. Once the token is provisioned, the token can be used to complete transactions or gain access to a restricted resource or location using the mobile device 130.

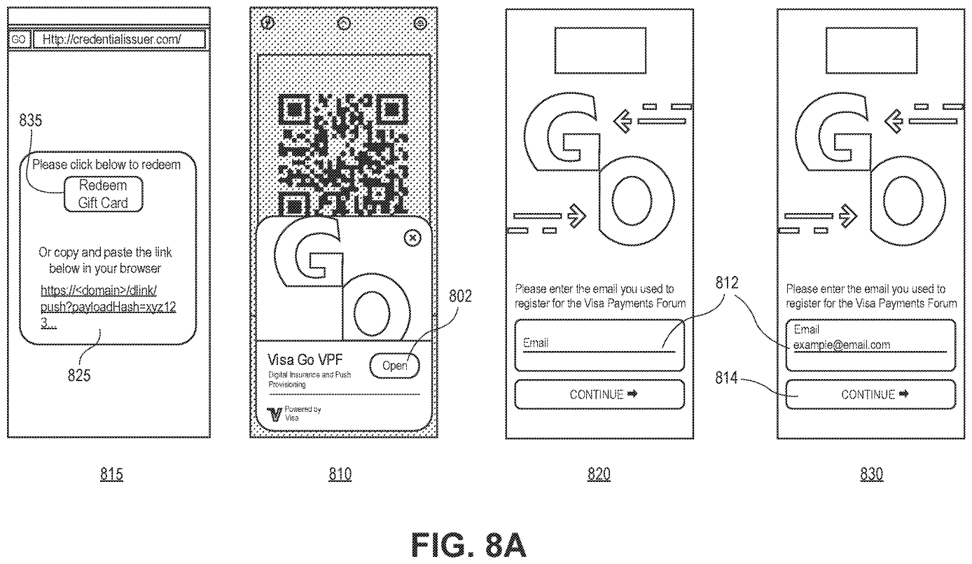

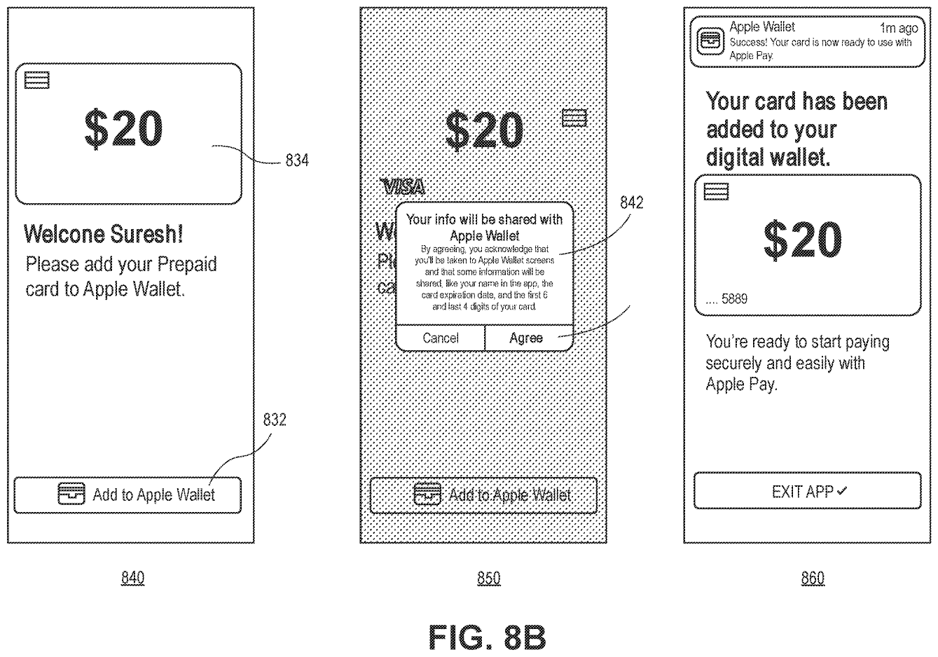

FIGS. 8A and 8B show screenshots of a mobile device (e.g., mobile device 130) performing a process using a remote resource address according to some embodiments. A QR code screen 810 (or a web browser screen 815), portion screens 820 and 830, a welcome screen 840, a notification screen 850, and a confirmation screen 860 can be shown to perform the process of provisioning a payment card or other credentials (i.e., plaintext user data) into a digital wallet (e.g., digital wallet 140).

The mobile device 130 can display the QR code screen 810. The QR code screen 810 can be displayed after the user scans a QR code including the remote resource address using as camera or sensor of the mobile device 130. The remote resource address can include encrypted user data with encryption of a payment card such as PAN, expiration date, etc.

In another embodiment, the mobile device 130 can display a selectable hyperlink 825 or button 835. The user can navigate to the link 825 or button 835 to access the remote resource address. In some embodiments, the hyperlink can be the remote resource address itself.

The remote resource address can be associated with the server computer 120 and can be generated in response to a request from the credential issuer computer 110 to generate a remote resource address for the user. The remote resource address can also include configuration information to launch an application 135 or a portion of the application 135 used to perform a process of provisioning the payload, part of the plaintext user data, into a digital wallet 140 of the mobile device 130. The user can click an open button 802 to launch the portion of the application 135, thereby transmitting the payload to the server computer 120 and receiving, in response, a token provisioned on the digital wallet 140.

The mobile device 130 can display the portion screens 820 and 830 upon clicking the open button 802. The portion screen 820 can include an input field configured to receive information to authenticate the mobile device 130 or the user. In the portion screen 820, the user can provide an email address 812 to continue with the push provision. In the portion screen 830, the email address may be input by the user. The user can select continue button 814 to continue with the push provision of the token.

In some embodiments, the mobile device 130 can display the wallet screen 840. The wallet screen 840 can provide an add wallet button 832 such that the user can finalize provisioning the payload (e.g., payment card) on the digital wallet 140. The wallet screen 840 can also display the payload information 834. In this example, the payload information can include a value such as $20 that may be associated with the plaintext credential (e.g., an account number). Upon the user clicking the add wallet button 832, the mobile device 130 can launch a notification screen 850.

The mobile device 130 can display the notification screen 850. The notification screen 850 can display a notification confirming that the payload will be shared with the digital wallet 140. Upon the user clicking or selecting an agree button 842A from the notification 842, the mobile device 130 can display the confirmation screen 860 with detailed information about the payment card added to the digital wallet 140.

Disclosed embodiments present several advantages over current provisioning technologies. For example, disclosed systems and methods enable a user to provision a credential on a digital wallet without being required to download and install an application on their mobile device. This improves the user experience and facilitates seamless integration of provisioning functionality into the mobile device.

For example, by obviating the need to download and install an application, the lightweight application enables a user to provision a credential without being limited due to lack of available memory on the mobile device. In other examples, the lightweight application acquired and executed by the mobile device enables a user to provision credentials on the mobile device without administrator approval. In another example, disclosed systems and methods enable a user to provision a credential on a digital wallet even if the user has limited bandwidth or limited available data usage.

Further, disclosed embodiments improve user privacy and increase user data protection. For example, when an application is downloaded on a user device, information about the user of the user device is shared with the resource provider or entity managing the application. Thus, the user may be reluctant to download any application on their user device unless absolutely necessary. Disclosed embodiments reduce the risk of loss of privacy or data leaks because the user can provision credentials on the digital wallet without downloading an application and having to accept terms of use prior to provisioning credentials. Accordingly, embodiments provide for improved data security, and prevent sharing personal information with third parties against the wishes of the owner of the personal information. Therefore, embodiments allow for compliance with domestic and foreign data privacy laws and regulations (e.g., General Data Protection Regulation (GDPR), California Consumer Privacy Act (CCPA)).

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or integrated circuit assemblies memory such as a flash memory or a solid state storage, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive, and that embodiments are not to be limited to the specific arrangements and constructions shown and described, since various other modifications may occur to those with ordinary skill in the art.

As used herein, the use of “a,” “an,” or “the,” is intended to mean “at least one,” unless specifically indicated to the contrary.

1. A method comprising:
receiving, by a server computer, credentials associated with a user account;
encrypting, by the server computer, the credentials with an encryption key to generate encrypted credentials, wherein the encrypted credentials are unique to the user account;
generating, by the server computer, a payload in form of a remote resource address, wherein the payload comprises the encrypted credentials;
generating, by the server computer, an application associated with the remote resource address;
transmitting, by the server computer, the application to a mobile device in response to the mobile device navigating to the remote resource address, wherein navigating to the remote resource address on the mobile device triggers execution of the application on the mobile device without the application being installed thereon;
receiving, by the server computer from the mobile device, the payload from the application when the application is executed on the mobile device, wherein the application retrieves the payload from the remote resource address; and
provisioning, by the server computer, a token associated with the user account on a digital wallet of the mobile device when the application is executed on the mobile device without being installed thereon.

2. The method of claim 1, further comprising:
rendering, by the server computer, a graphical user interface associated with an application generation platform of the server computer on the mobile device, wherein the graphical user interface includes a field for receiving the credentials associated with the user account, wherein the application generation platform receives the credentials from the graphical user interface.

3. The method of claim 1, wherein receiving the payload from the application further comprises:
receiving, by the server computer, the payload when the application is executed on the mobile device;
decrypting, by the server computer, the encrypted credentials in the payload using the encryption key;
identifying, by the server computer, the token associated with the credentials;
receiving, by the server computer, a selection of the digital wallet from the mobile device; and
provisioning, by the server computer, the token on the digital wallet.

4. The method of claim 1, wherein provisioning the token on the digital wallet adds payment capability to the mobile device using the token.

5. The method of claim 1, further comprising:
generating, by the server computer, a payload hash of the payload; and
incorporating, by the server computer, the payload hash in the remote resource address.

6. The method of claim 1, wherein the application is a lightweight application configured to support provisioning the token on the digital wallet.

7. The method of claim 1, wherein receiving the payload from the application further comprises:
authenticating, by the server computer, the mobile device and a user of the mobile device;
generating, by the server computer, session keys to communicate with the mobile device;
transmitting, by the server computer, the session keys to the mobile device;
initializing, by the server computer, a session with the mobile device using the session keys; and
retrieving, by the server computer, the payload from the remote resource address.

8. The method of claim 1, wherein navigating the remote resource address on the mobile device executes the application on the mobile device.

9. The method of claim 1, wherein the application is configured to vanish from the mobile device once the token is provisioned on the digital wallet.

10. The method of claim 1, wherein executing the application on the mobile device creates an encrypted communication channel between the mobile device and the server computer,
wherein the server computer receives the payload from and transmits the token to the mobile device via the encrypted communication channel.

11. A server computer comprising:
one or more processors; and
a computer readable medium comprising code, executable by the one or more processors to perform steps comprising:
receiving credentials associated with a user account;
encrypting the credentials with an encryption key to generate encrypted credentials, wherein the encrypted credentials are unique to the user account;
generating a payload in form of a remote resource address, wherein the payload comprises the encrypted credentials;
generating an application associated with the remote resource address and the encrypted credentials;
transmitting the application incorporating the remote resource address to a mobile device in response to the mobile device navigating to the remote resource address, wherein navigating to the remote resource address on the mobile device triggers execution of the application on the mobile device without the application being installed thereon;
receiving, from the mobile device, the payload from the application when the application is executed on the mobile device, wherein the application retrieves the payload from the remote resource address; and
provisioning a token associated with the user account on a digital wallet of the mobile device when the application is executed on the mobile device without being installed thereon.

12. The server computer of claim 11, wherein receiving the payload from the application further comprises:
receiving the payload when the application is executed on the mobile device;
decrypting the encrypted credentials in the payload using the encryption key;
identifying the token associated with the credentials;
receiving a selection of the digital wallet from the mobile device; and
provisioning the token on the digital wallet.

13. The server computer of claim 11, wherein the code, when executed by the one or more processors, further perform steps comprising:
generating a payload hash of the payload; and
incorporating the payload hash in the remote resource address.

14. The server computer of claim 11, wherein the application is a lightweight application configured to support provisioning the token on the digital wallet and further configured to vanish from the mobile device once the token is provisioned on the digital wallet.

15. The server computer of claim 11, wherein receiving the payload from the application further comprises:
authenticating the mobile device and a user of the mobile device;
generating session keys to communicate with the mobile device;
transmitting the session keys to the mobile device;
initializing a session with the mobile device using the session keys; and
retrieving the payload from the remote resource address.

16. The server computer of claim 11, wherein navigating the remote resource address on the mobile device executes the application on the mobile device.

17. The server computer of claim 11, wherein executing the application on the mobile device creates an encrypted communication channel between the mobile device and the server computer,
wherein the server computer receives the payload from and transmits the token to the mobile device via the encrypted communication channel.

18. A method comprising:
receiving, at a mobile device, a message including a remote resource address comprising encrypted user data, the remote resource address associated with a server computer;
receiving, by the mobile device, a selection of the remote resource address;
responsive to the selection, navigating, by the mobile device, to the remote resource address;
responsive to navigating, receiving, by the mobile device, an application;
executing, by the mobile device, the application on the mobile device without installing the application, wherein the application vanishes from the mobile device upon execution;
receiving, by the mobile device, a token from the server computer in response to executing the application on the mobile device, wherein the token is provisioned on a digital wallet of the mobile device; and
conducting, by the mobile device, a transaction using the token provisioned on the mobile device.

19. The method of claim 18, further comprising:
establishing an encrypted communication channel between the mobile device and the server computer upon executing the application on the mobile device, wherein the mobile device receives the token from the server computer via the encrypted communication channel.

20. The method of claim 18, wherein the application is a lightweight application configured to support provisioning the token on the digital wallet.
